(19) United States
(12) Patent Application Publication
(10) Pub. No.: US 2004/0016714 A1
(43) Pub. Date: Jan. 29, 2004

(54) Elastomeric hinge for a closure lid

(76) Inventors: Christopher J. Wood, Milwaukee, WI (US); Charles E. Roberts, Eagle, WI (US); Milton R. Dallas, East Troy, WI (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/623,625

(22) Filed: Jul. 21, 2003

Related U.S. Application Data
(63) Continuation of application No. 09/715,688, filed on Nov. 17, 2000.

(51) Int. Cl. B65D 43/14; E05F 1/08

(52) U.S. Cl. 215/235; 220/847; 16/277

(57) ABSTRACT

A hinge structure is provided for connecting two members, such as a container closure base and lid, so as to accommodate movement between an open position and a closed position. An elastomeric element extends from one of the members to the other of the members. The elastomeric element has an outer surface that is outwardly exposed when the two members are in the closed position as well as when the two members are in the open position. The elastomeric element exerts a force to urge the two members from the closed position toward the open position. In one embodiment, the elastomeric element has two lateral margins, and the hinge structure is free of structure laterally of the elastomeric element so that the two lateral margins are laterally exposed when the two members are in the closed position as well as when the two members are in the open position. The elastomeric element outer surface is in tension when the two members are in the closed position.

### CROSS REFERENCE TO RELATED APPLICATION

This is a continuation of prior application Ser. No. 09/715,688, filed Nov. 17, 2000.

### TECHNICAL FIELD

This invention relates to a hinge structure for connecting two members, and the hinge structure is particularly suitable for joining a lid to a base or body of a closure for a container.

### BACKGROUND OF THE INVENTION AND TECHNICAL PROBLEMS POSED BY THE PRIOR ART

A variety of packages, including dispensing packages or containers, have been developed for personal care products such as shampoo, lotions, etc., as well as for other fluid materials. One type of closure for these kinds of containers typically has a bistable hinge structure connecting a lid to a base mounted over the container opening. The hinge structure has a snap-action biasing force which maintains the lid in a selected closed or open position.

One type of bistable hinge structure incorporated in a closure is disclosed in U.S. Pat. No. 3,135,456. This patent discloses a snap-action hinge structure comprising a thin hinge web joining a base and a lid to accommodate movement of the lid between an open and closed position. The hinge structure has two, spaced-apart pivot axes. In particular, the hinge structure incorporates two, spaced-apart hinges, one hinge having an arcuate configuration connecting the lid to the hinge web and the other hinge having an arcuate configuration connecting the base to the hinge web. The two pivot axes are defined by two parallel lines wherein, at points where the two hinges are closest to each other, one line is tangent to the lid hinge and the other line is tangent to the body hinge.

In contrast, the hinge structure for a cylindrical closure disclosed in U.S. Pat. No. 4,403,712 has a single, main geometric axis hinge and has two webs which each is defined by two hinges which diverge on either side of the web. In commercial embodiments of the cylindrical closure having a single axis hinge structure disclosed in the U.S. Pat. No. 4,403,712, the hinge thickness changes along the length of the hinges. The thickness transition regions can define stress risers which may ultimately have a deleterious effect upon the structure during repeated operation.

Also, in some commercial closures which are sold by Seaquist Closures, 711 Fox Street, Box 20, Mukwonago, Wis. 53149, U.S.A., and which include the single axis hinge structure disclosed in U.S. Pat. No. 4,403,712, the web is provided with an increased thickness region adjacent the lateral edge of the web.

A snap-action hinge structure with significant improved operating characteristics compared to the hinge structures disclosed in the U.S. Pat. Nos. 3,135,456 and 4,403,712 is a dual axis hinge structure disclosed in the U.S. Pat. No. 5,642,824. The hinge structure is of the type that includes a web having a central portion between two wider ends wherein an arcuate hinge connects the base to the web along one side of the web between the ends and wherein an arcuate hinge connects the lid to the web along another side of the web between the ends. The hinge structure includes at least one abutment surface located so that when the lid is in the closed position, the abutment surface extends adjacent the web central portion from near one of the hinges toward the other hinge. During the closing and opening of the lid, the abutment surface is contacted by the web central portion whereby the position of the web is controlled.

Although the dual axis hinge structure disclosed in U.S. Pat. No. 5,642,824 functions with improved operating characteristics, there are some applications, such as those involving a large number of opening and closing cycles, in which the dual axis hinge structure, as well as other biased hinge structures or bistable, snap-action hinge structures, may be more likely to fail or break.

It is believed that in a snap-action hinge structure which includes a web having a wide end, the stresses are unevenly distributed along the lateral edge of the web end. This is thought to increase the stresses where the lateral edge connects with the closure body and lid. Failure or fracture of such hinge structures is typically initiated at those regions where a lateral edge of the hinge structure web connects with the closure body and/or lid.

Thus, it would be desirable to provide an improved snap-action hinge design in which the stresses in the hinge structure could be more carefully controlled. In particular, it would be beneficial if such an improved design could provide an even distribution of stress along the outer, lateral edges of the hinge structure.

It would be especially desirable to provide a hinge structure which would have reduced stresses where the hinge structure web lateral edges connect with the closure body and/or lid.

An improved hinge structure design should also permit the hinge structure to provide the desired opening and closing angle range for the lid. A hinge structure with such a capability can provide performance features that are desirable in particular applications.

Also, it would be desirable if such an improved hinge structure could be readily incorporated in a closure that would accommodate efficient, high quality, large volume manufacturing techniques with a reduced product reject rate.

Further, such an improved hinge structure should advantageously accommodate its use in closures with a variety of conventional containers having a variety of conventional container finishes, such as conventional threaded or snap-fit attachment configurations.

The present invention provides an improved hinge structure which can accommodate designs having the above-discussed benefits and features.

### SUMMARY OF THE INVENTION

According to the present invention, a hinge structure is provided for connecting two members, and the hinge structure is particularly suitable for use in connecting a closure lid to the base of the closure wherein the closure is adapted to be mounted to, or formed as a unitary part of, a container.

The hinge structure has enhanced opening characteristics. The hinge structure may be bi-injection molded integral with the two members, such as the closure lid and the closure base.

The hinge structure has an elastomeric element that extends from one of the members to the other of the members. The elastomeric element has an outer surface that is outwardly exposed when the two members are in the closed position as well as when the two members are in the open position. The elastomeric element exerts a force to urge the two members from the closed position toward the open position. A latch may be provided with cooperating features in the two members to hold the two members in the closed position until they are unlatched.

In one embodiment, the elastomeric element has two lateral margins. The two members do not have any structure or portions which lie adjacent the elastomeric element lateral margins. The hinge structure also does not have any portions which lie adjacent the elastomeric element lateral margins. That is, the hinge structure is free of structure laterally of the elastomeric element so that the two lateral margins of the elastomeric element are laterally exposed when the two members are in the closed position as well as when the two members are in the open position. The elastomeric element outer surface is in tension when the two members are in the closed position.

According to one preferred embodiment, an elastomeric element extends from one of the members to the other of the members and has an outer surface that is (1) outwardly exposed when the two members are in the closed position as well as when the two members are in the open position, and (2) in tension when the two members are in the closed position. The elastomeric element has an inner surface that is exposed so as to face generally away from the two members when the two members are in the open position and that faces inwardly toward the two members when the two members are in the closed position. The elastomeric element inner surface is in compression when the two members are in the closed position. The elastomeric element exerts a force to urge the two members from the closed position toward the open position.

According to another embodiment, a film hinge connects the two members. An elastomeric element extends from one of the two members to the other of the members. The elastomeric element has an outer surface that is (1) outwardly exposed when the two members are in the closed position as well as when the two members are in the open position, and (2) in tension when the two members are in the closed position. The elastomeric element has an inner surface that is bonded to the film hinge and that is a substantially neutral stress surface when the two members are in the closed position. The elastomeric element exerts a force to urge the two members from the closed position toward the open position.

Numerous other advantages and features of the present invention will become readily apparent from the following detailed description of the invention, from the claims, and from the accompanying drawings.

### BRIEF DESCRIPTION OF THE DRAWINGS

In the accompanying drawings forming part of the specification, in which like numerals are employed to designate like parts throughout the same,

FIG. 1 is a perspective view of a first embodiment of a hinge structure of the present invention as incorporated in a closure shown in the as-molded open position;

FIG. 2 is a top plan view of the closure in the fully open, as-molded condition;

FIG. 3 is a bottom view of the closure in the fully open, as-molded condition;

FIG. 4 is a fragmentary, cross-sectional, elevational view of the closure shown in the as-molded, open condition and mounted on a container;

FIG. 5 is a fragmentary, cross-sectional view showing a greatly enlarged portion of the hinge structure illustrated in FIG. 4;

FIG. 6 is a greatly enlarged, fragmentary, cross-sectional view taken generally along the plane 6-6 in FIG. 5;

FIG. 7 is a rear elevational view of the closure in the fully closed condition;

FIG. 8 is a greatly enlarged, fragmentary, cross-sectional view taken generally along the plane 8-8 in FIG. 7;

FIG. 9 is a view similar to FIG. 8, but FIG. 9 shows the lid of the closure moved to an intermediate position between the full closed position and the full open condition;

FIG. 10 is a perspective view of a second embodiment of a hinge structure of the present invention as incorporated in a closure shown in the as-molded open position;

FIG. 11 is a top plan view of the closure of FIG. 10 in the fully open, as-molded condition;

FIG. 12 is a bottom view of the closure of FIG. 10 in the fully open, as-molded condition;

FIG. 13 is a fragmentary, cross-sectional, elevational view of the closure of FIG. 10 shown in the as-molded, open condition and mounted on a container;

FIG. 14 is a fragmentary, cross-sectional view showing a greatly enlarged portion of the hinge structure illustrated in FIG. 10;

FIG. 15 is a greatly enlarged, fragmentary, cross-sectional view taken generally along the plane 15-15 in FIG. 14;

FIG. 16 is a rear elevational view of the closure of FIG. 10 in the fully closed condition;

FIG. 17 is a greatly enlarged, fragmentary, cross-sectional view taken generally along the plane 17-17 in FIG. 16;

FIG. 18 is a view similar to FIG. 17, but FIG. 18 shows the lid of the closure moved to an intermediate position between the full closed position and the full open condition;

FIG. 19 is a perspective view of a third embodiment of a hinge structure of the present invention as incorporated in a closure shown in the as-molded open position;

FIG. 20 is a top plan view of the closure of FIG. 19 in the fully open, as-molded condition;

FIG. 21 is a bottom view of the closure of FIG. 19 in the fully open, as-molded condition;

FIG. 22 is a fragmentary, cross-sectional, elevational view of the closure of FIG. 19 shown in the as-molded, open condition and mounted on a container;

FIG. 23 is a fragmentary, cross-sectional view showing a greatly enlarged portion of the hinge structure illustrated in FIG. 19;

FIG. 24 is a greatly enlarged, cross-sectional view taken generally along the plane 24-24 in FIG. 23;

FIG. 25 is a rear elevational view of the closure of FIG. 19 in the fully closed condition;

FIG. 26 is a greatly enlarged, fragmentary, cross-sectional view taken generally along the plane 26-26 in FIG. 25; and

FIG. 27 is a view similar to FIG. 26, but FIG. 27 shows the lid of the closure moved to an intermediate position between the full closed position and the full open condition.

### DESCRIPTION OF THE PREFERRED EMBODIMENTS

While this invention is susceptible of embodiment in many different forms, this specification and the accompanying drawings disclose only some specific forms as examples of the invention. The invention is not intended to be limited to the embodiments so described, and the scope of the invention will be pointed out in the appended claims.

For ease of description, a closure incorporating the hinge structure of this invention is described in various positions, and terms such as upper, lower, horizontal, etc., are used with reference to these positions. It will be understood, however, that the closure may be manufactured, stored, and used in orientations other than the ones described.

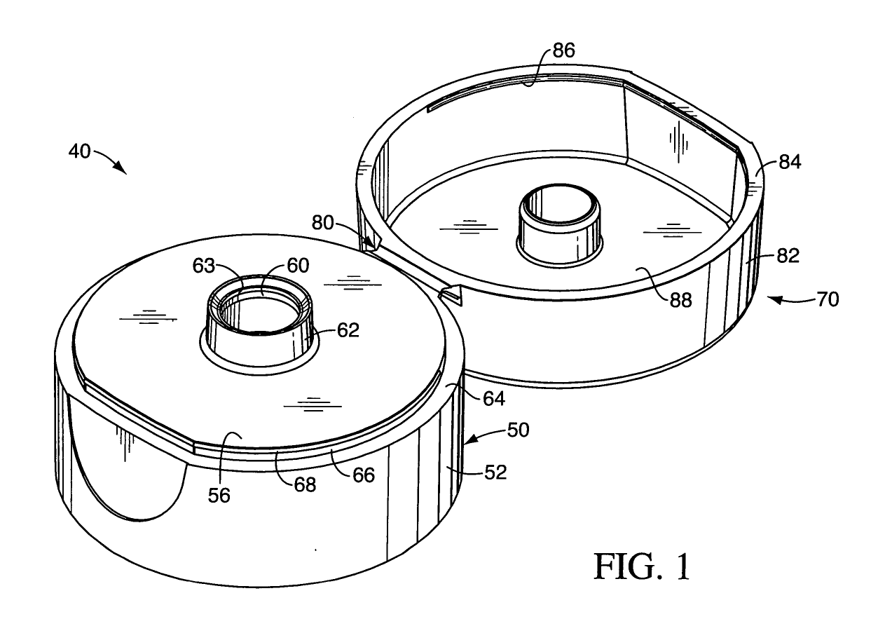

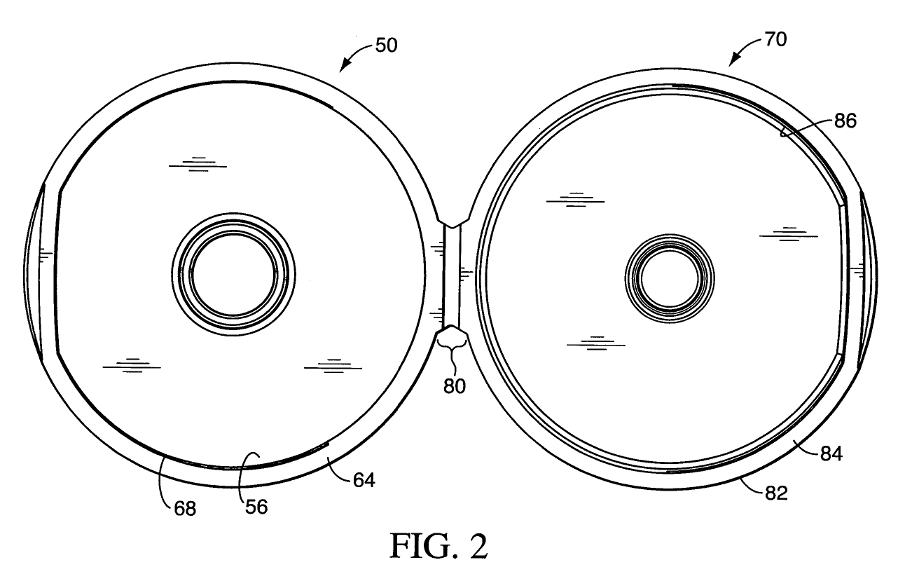

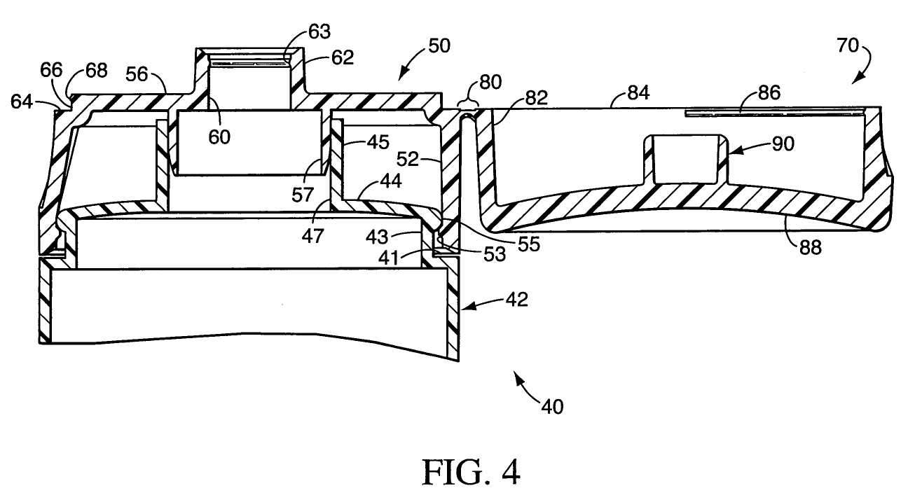

With reference to the figures, a first embodiment of a hinge structure of the present invention is illustrated in FIGS. 1-9 as incorporated in a closure represented generally in some of those figures by reference number 40. The closure 40 is adapted to be disposed on a container, such as a container 42 (FIG. 4) which has a shoulder 41 around a reduced diameter wall 43. The wall 43 terminates in a top end wall 44 (FIG. 4) from which projects a reduced diameter neck 45 (FIG. 4) which has a conventional mouth or opening 47. The container neck 45 may have a circular or non-circular cross-sectional configuration, and the body of the container 42 may have another cross-sectional configuration, such as an oval cross-sectional shape, for example. The container 42 need not have a shoulder 41 or reduced diameter neck 45. The closure 40 could be adapted to fit on the upper end of a container that does not have a reduced diameter neck per se. The closure 40 is preferably molded from a thermoplastic material or materials compatible with the container contents.

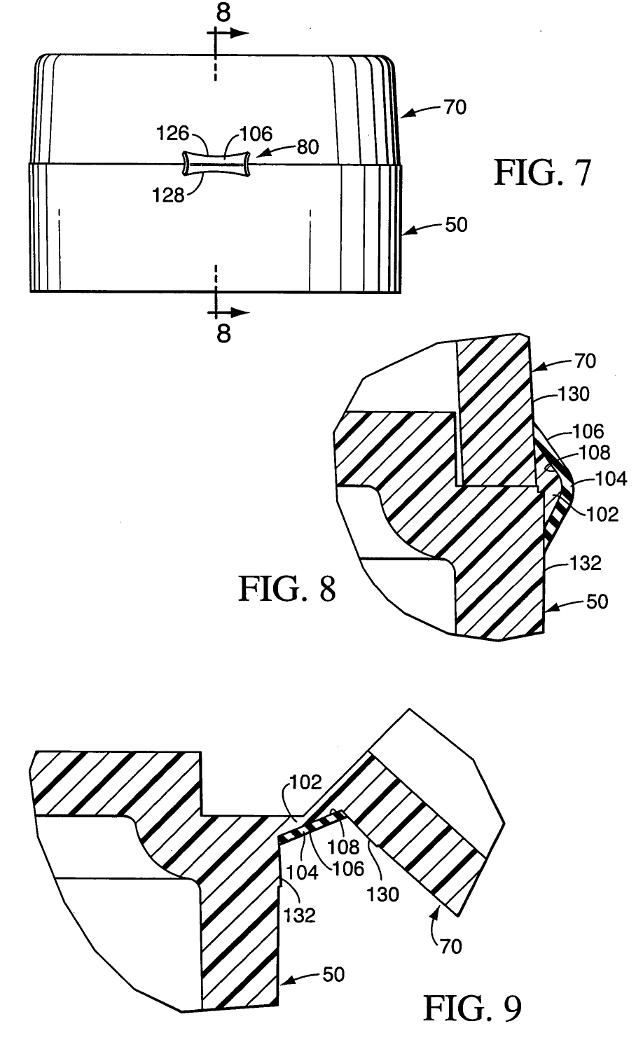

The container 42 may be stored and used in the orientation shown in FIG. 4 wherein the closure 40 is at the top of the container 42. When the closure 40 is in a closed condition (FIG. 7), the closure 40 and container 42 may also be normally stored in an inverted position (not illustrated). When stored in the inverted position, the container 42 employs the closure 40 as a support base.

The container 42 is typically a squeezable container having a flexible wall or walls which can be grasped by the user and compressed to increase the internal pressure within the container 42 so as to squeeze the product out of the container when the closure 40 is opened (as explained in detail hereinafter). The container wall typically has sufficient, inherent resiliency so that when the squeezing forces are removed, the container wall returns to its normal, unstressed shape.

The closure 40 includes a base or body 50 (FIGS. 1 and 4) for being mounted to the container 42. The base 50 includes a skirt 52 (FIG. 4) which has a conventional snap-fit bead 53 means for engaging a mating bead 55 on the container wall 43 to secure the closure base 50 to the container 42. The closure body 50 could alternatively include an interior, annular connector wall with internal threads for engaging external threads on the container wall 43. Other suitable connecting systems could be employed.

At the top of the closure base skirt 52, the closure base 50 has a transverse deck 56 (FIG. 4) which extends over the upper, distal end of the container 42. The deck 56 typically has a downwardly extending, annular, internal flexible seal 57 which is received against the inner edge of the container neck 45 in the container neck opening 47 so as to provide a leak-tight seal between the closure base deck 56 and the container neck 45.

As illustrated in FIGS. 1 and 4, the closure base deck 56 has a discharge aperture 60 defined by a spout 62 projecting upwardly over the container neck opening 47. There is a seal bead 63 on the inside of the spout 62.

The closure base 50 has a shoulder 64 at the base of a peripheral wall 66 around the deck 56, and there is a bead 68 on the wall 66 around the deck 56 above the shoulder 64.

The closure 40 includes a lid 70 (FIGS. 1-4) connected to the base 50 with a hinge structure 80. The lid 70 includes a peripheral skirt 82 (FIG. 1) defining a peripheral termination surface 84. The lid peripheral surface 84 is adapted to contact, or at least confront, the closure base shoulder 64 when the lid 70 is closed on the base shoulder 64. Preferably, as illustrated in FIG. 4, the lid skirt 82 has an interior bead 86 for engaging the closure base bead 68 to latch the lid 70 in the closed position.

The closure lid 70 includes a transverse deck or cover 88 (FIG. 1). Extending from the underside of the lid cover 88 is an annular member 90 which is adapted to be received in, and sealingly engage the interior of, the closure base spout 62 when the lid 70 is closed.

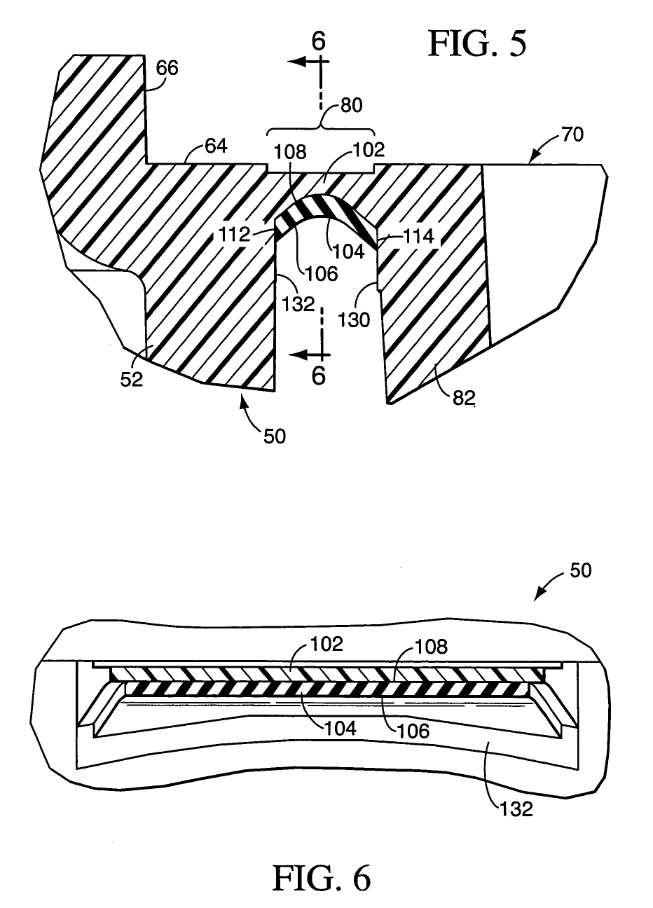

In the first embodiment illustrated in FIGS. 1-9, the hinge structure 80 includes a film hinge 102 (FIG. 5) connecting the two members of the closure structure—the closure body or base 50 and the lid 70. In a presently contemplated preferred embodiment, the film hinge 102 is integrally molded as a unitary part of the closure, and is therefore unitary with the closure base 50 and the lid 70. A preferred material is polypropylene, although other thermoplastic polymers may be employed, such as polyethylene.

An elastomeric element 104 extends from the closure base 50 to the closure lid 70. The elastomeric element has an outer surface 106. The outer surface 106 is outwardly exposed when the closure base 50 and lid 70 are in the closed position (FIGS. 7 and 8) as well as when the base 50 and lid 70 are in the open position (FIGS. 1 through 4 and 9). That is, the surface 106 can be accessed from regions on the exterior surfaces of the closure base 50 and lid 70. The elastomeric element 104 has an inner surface 108 which is bonded to the film hinge 102.

The elastomeric element 104 may be made from a thermoplastic polymer, such as the styrene-ethylene-butadiene-styrene compound sold in the U.S.A. by GLS Corporation under the trade name DYNAFLEX G2706. This is a thermoplastic rubber compound. This material may be molded on the thermoplastic film hinge 102 in a two-stage or bi-injection type molding process. The thermoplastic elastomer material bonds to the polypropylene film hinge in such a process. The DYNAFLEX G2706 thermoplastic rubber compound is very elastic and advantageously tends to resist relaxation when subjected to strain. Further, this material contains some polypropylene, and this assists in bonding the material in a bi-injection molding process to closure components which are molded from polypropylene.

Preferably, as shown in FIG. 5, the thermoplastic elastomeric element 104 has a transverse end 112 abutting the exterior peripheral surface of the closure base skirt 52 and has a transverse end 114 abutting the exterior peripheral surface of the lid skirt 82. The elastomeric element ends 112 and 114 are bonded to the exterior peripheral surfaces of the base 50 and lid 70, respectively. Other means for attaching the elastomeric element 104 to the film hinge 102, base 50, and lid 70 may be employed, such as adhesive.

When employing a design in which the elastomeric element 104 is adhesively secured, the elastomeric element 104 is first made separately so that it has the size and configuration that corresponds to the outside of the film hinge 102 when the closure is in the fully open condition as illustrated in FIGS. 1, 2, 3, 4, 5, and 6. Thus, the elastomeric element 104 would initially have an arcuate configuration (FIG. 5). The elastomeric element 104 would be adhesively secured to the outside surface of the film hinge 102 when the closure base 50 and lid 70 are in the fully opened condition (FIG. 5). The elastomeric element transverse ends 112 and 114 would also be adhesively secured to the closure base 50 and lid 70, respectively, when the closure base 50 and lid 70 are in the fully opened condition (FIG. 5).

As initially molded or otherwise constructed, the hinge structure 80 is substantially unstressed in the initially open configuration. There is substantially no stress on the outer surface 106 or inner surface 108.

When the closure base 50 and lid 70 are in the closed position, the elastomeric element outer surface 106 is in tension but the elastomeric element inner surface 108 is a substantially neutral stress surface. The elastomeric element 104 exerts a force to urge the closure base 50 and lid 70 away from the closed position toward the open position.

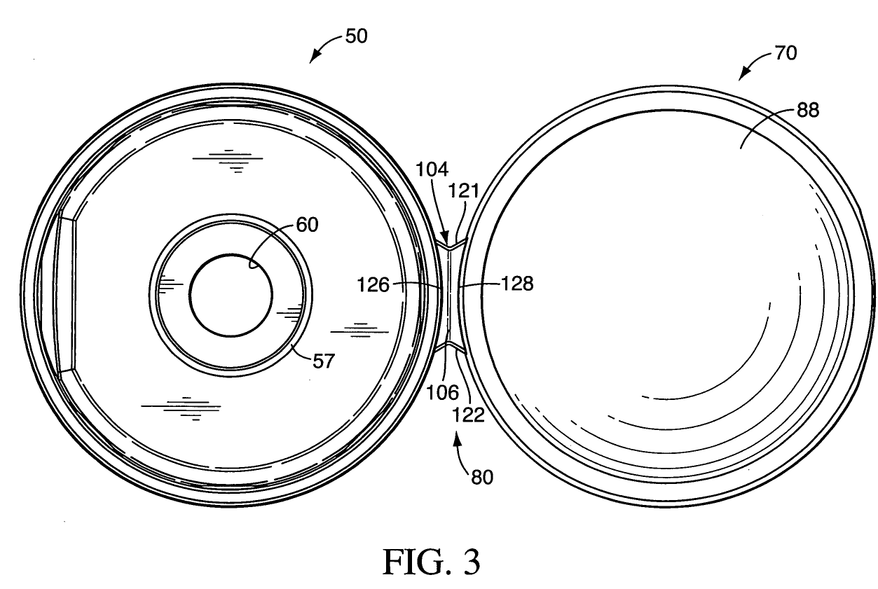

In the preferred embodiment illustrated in FIGS. 1-9, the elastomeric element 104 has two lateral margins 121 and 122 (FIG. 3). The hinge structure 80 is free of any other structure laterally of the elastomeric element 104 so that the two lateral margins 121 and 122 are laterally exposed when the closure base 50 and lid 70 are in the closed position as well as when the closure base 50 and lid 70 are in the open position. The lateral margins 121 and 122 are wider than the central part of the hinge structure as can be seen in FIG. 3. The hinge structure 80 has top and bottom edges 126 and 128, respectively, which are curved or arcuate in the vertical axial directions between the lateral margins 126 and 128 (FIGS. 3 and 7).

The elastomeric element lateral margins 121 and 122 (FIG. 3) will tend to be in tension along their entire outer edges if the base 50 and lid 70 are moved beyond the as-molded open condition (i.e., if the lid 70 is bent downwardly from the as-molded position illustrated in FIG. 1).

The above-described hinge structure illustrated in FIGS. 1-9 offers a number of advantages over widely used polypropylene snap-action hinges. For example, a currently employed prior art snap-action hinge molded from polypropylene must be manually opened beyond the over-center point and fulcrum point before the lid will be automatically biased by the hinge toward the full open position. The hinge structure of the present invention illustrated in FIGS. 1-9 will tend to pull the lid to the open position as soon as the latching beads (base bead 68 and lid bead 86) are disengaged.

Further, the present invention hinge structure shown in FIGS. 1-9 will tend to move the base 50 and lid 70 further apart to a more wide open orientation—closer to the original as-molded configuration.

Conventional closures are molded from thermoplastic material in a wide “open” configuration (i.e., with the lid open about 180° from the body or base). With conventional molded hinges, such as those molded entirely from polypropylene, it is desirable for the manufacturer to close the as-molded, open closure before more than about 10 minutes have elapsed after molding the closure. If the closure is initially closed after a longer time period, the hinge may become undesirably brittle during subsequent opening and closing cycles. This could lead to early hinge failure. Closing the closure within 10 minutes of molding, especially with polypropylene, tends to orient the macromolecular chains of the polymer so as to reduce the tendency to become brittle during subsequent opening and closing cycles. On the other hand, with the hinge structure of the present invention as shown in FIGS. 1-9, the maximum period of time in which the closure should be initially closed after molding is not as critical owing to the presence of the elastomeric element 104.

If the elastomeric element 104 is incorporated in the closure by means of bi-injection molding, the closure body or base 50 and the lid 70 are preferably provided with features to simplify or enhance the molding process. Specifically, as shown in FIG. 5, the lid skirt 82 is preferably provided with a small, generally flat area or pad 130 below the film hinge 102. Similarly, a small flat area or pad 132 is provided on the closure base below the film hinge 102. The pads or flat areas 130 and 132 eliminate mold draft in these regions adjacent the hinge structure. This permits a mold core blade (not illustrated) or other component to be positioned at a first location in the mold to tightly shut off the region of the mold adjacent the film hinge 102 until all of the polypropylene material has been injection-molded. Subsequently, the mold core blade can be withdrawn to a second location for the second part of the bi-injection molding process to provide a space adjacent the polypropylene film hinge so as to accommodate injection of the thermoplastic elastomer for forming the elastomeric element 104.

At the bottom end of each pad 130 and 132 (as viewed in FIG. 5), a typical draft angle or angles can be provided (e.g., a 1degree draft angle on the body skirt 52 and a 3degree draft angle on the lid skirt 82).

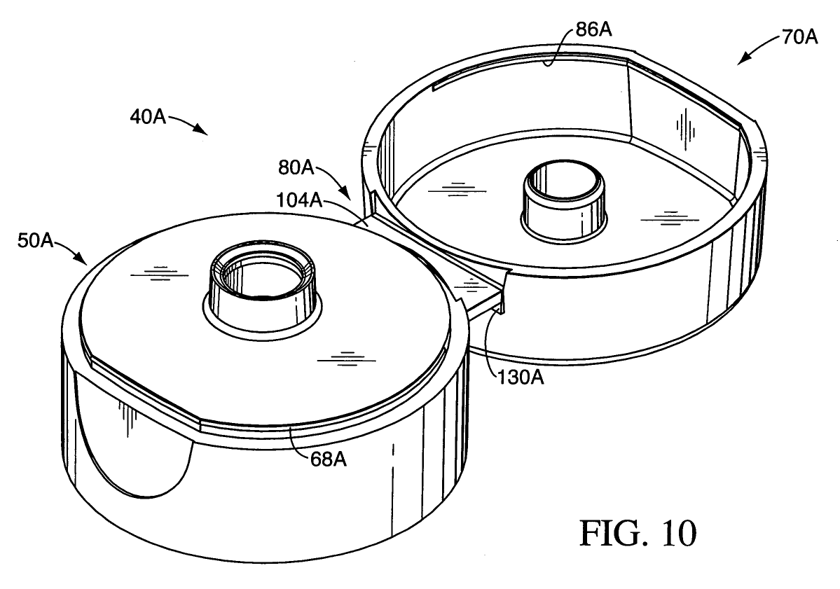

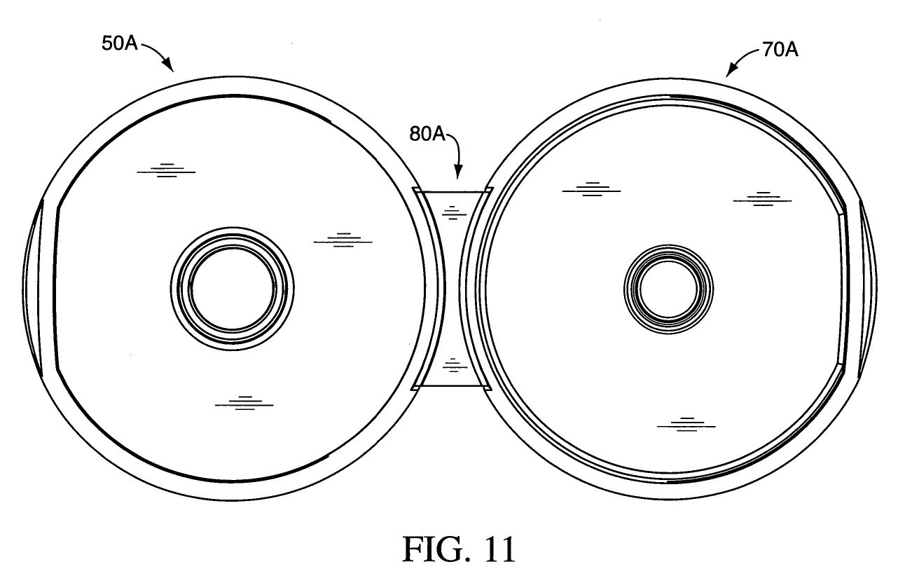

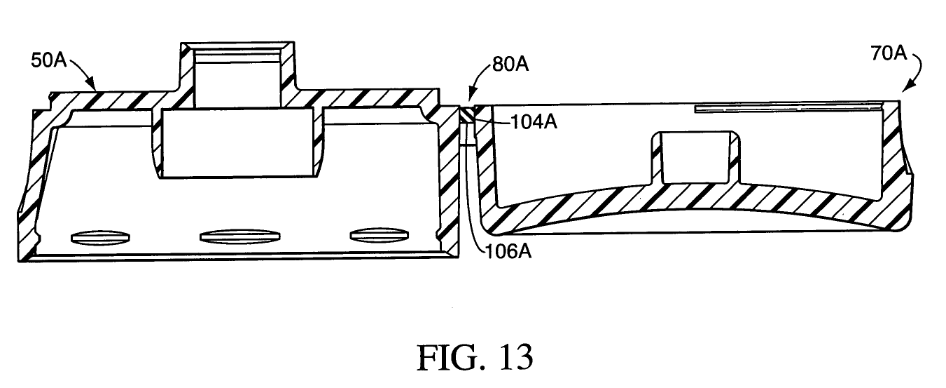

A second embodiment of the hinge structure of the present invention is illustrated in FIGS. 10-18 as embodied in a closure designated generally by the reference number 40A in FIG. 10. The closure 40A includes a closure base or body 50A and a lid 70A. The closure body 50A and lid 70A are each substantially identical with the first embodiment closure body 50 and lid 70, respectively, described above with reference to FIGS. 1-9.

In the second embodiment illustrated in FIGS. 10-18, a hinge structure 80A (FIG. 10) connects the two members of the closure structure—the closure body or base 50A and the lid 70A. Unlike in the first embodiment, there is no film hinge (e.g., film hinge 102 shown in FIG. 5 for the first embodiment). Rather, the second embodiment hinge structure 80A consists only of an elastomeric element 104A.

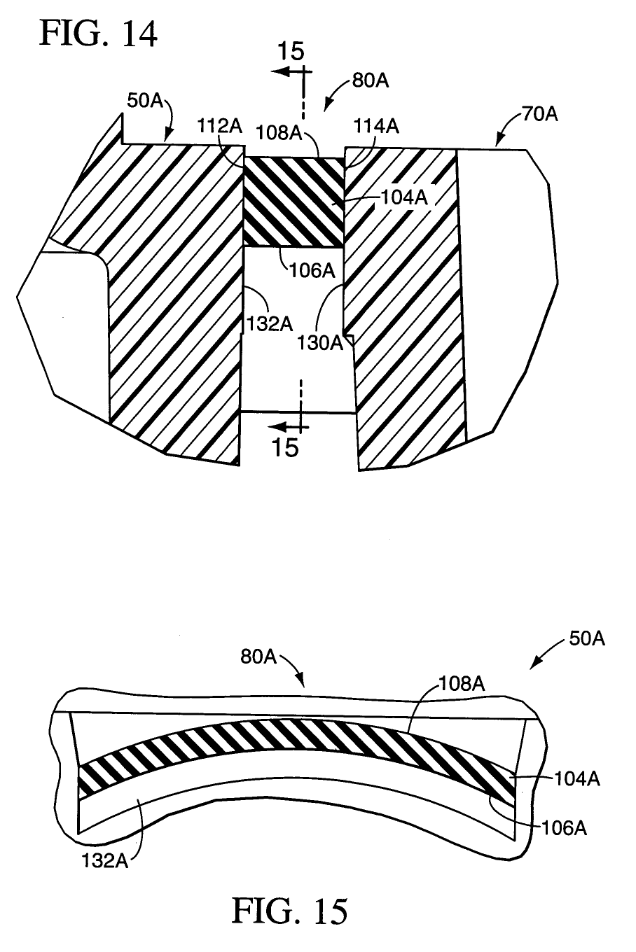

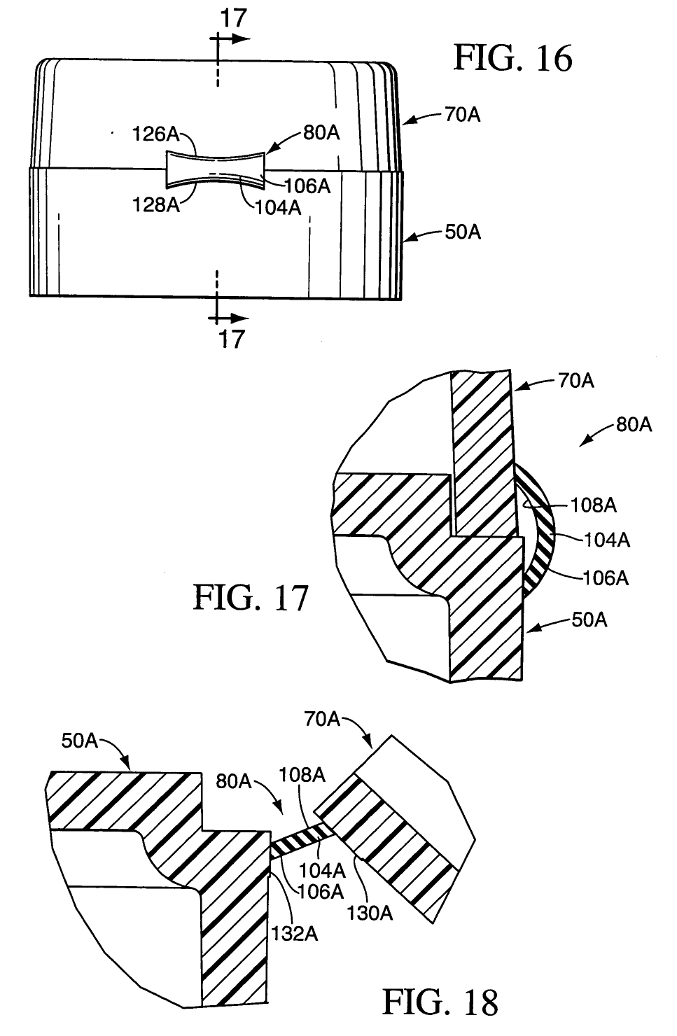

The elastomeric element 104A extends from the closure base 50A to the closure lid 70A. The elastomeric element 104A has an outer surface 106A. The outer surface 106A is outwardly exposed when the closure base 50A and lid 70A are in the closed position (FIGS. 16 and 17) as well as when the base 50A and lid 70A are in the open position (FIGS. 10 through 15 and 18). That is, the surface 106A can be accessed from regions on the exterior surfaces of the closure base 50A and lid 70A. The elastomeric element 104A has an inner surface 108A which faces the closure body 50A and lid 70A when the closure is closed (FIG. 17).

The elastomeric element 104A may be made from a thermoplastic polymer, such as the above-discussed styrene-ethylene-butadiene-styrene thermoplastic rubber compound sold in the U.S.A. by GLS Corporation under the trade name DYNAFLEX G2706. This material may be molded to the closure body 50A and lid 70A in a two-stage or bi-injection type molding process. The thermoplastic elastomer material bonds to the closure body and lid material, such as polypropylene, in such a process.

Preferably, as shown in FIG. 14, the thermoplastic elastomeric element 104A has a transverse end 112A abutting the exterior peripheral surface of the closure base 50A and has a transverse end 114A abutting the exterior peripheral surface of the lid 70A. The elastomeric element ends 112A and 114A are bonded to the exterior peripheral surfaces of the base 50A and lid 70A, respectively. Other means for attaching the elastomeric element 104A, base 50A, and lid 70A may be employed, such as adhesive.

When employing a design in which the elastomeric element 104A is adhesively secured, the elastomeric element 104A is first made separately so that it has the size and configuration that fits to, or corresponds to, the configuration of the closure when the closure is in the fully open condition as illustrated in FIGS. 10-15. The elastomeric element 104A would be adhesively secured to the outside surfaces of the closure base 50A and lid 70A when the closure base 50A and lid 70A are in the fully opened condition (FIG. 14).

As initially molded or otherwise constructed, the hinge structure 80A is substantially unstressed in the initially open configuration. There is substantially no stress on the outer surface 106A or inner surface 108A.

When the closure base 50A and lid 70A are in the closed position, the elastomeric element outer surface 106A is in tension, but the elastomeric element inner surface 108A is in compression. The elastomeric element 104A exerts a force to urge the closure base 50A and lid 70A away from the closed position toward the open position.

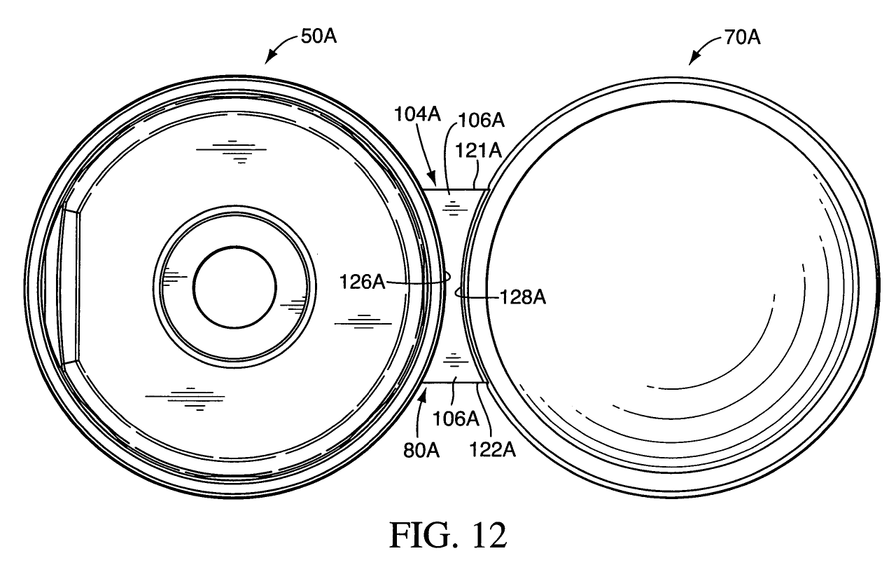

In the second embodiment illustrated in FIGS. 10-18, the elastomeric element 104A has two lateral margins 121A and 122A (FIG. 12). The hinge structure 80A is free of any other structure laterally of the elastomeric element 104A so that the two lateral margins 121A and 122A are laterally exposed when the closure base 50A and lid 70A are in the closed position as well as when the closure base 50A and lid 70A are in the open position. The lateral margins 121A and 122A are wider than the central part of the hinge structure as can be seen in FIG. 12. The hinge structure 80A has top and bottom edges 126A and 128A, respectively, which are curved or arcuate in the vertical axial directions between the lateral margins 126A and 128A (FIG. 16).

The elastomeric element lateral margins 121A and 122A (FIG. 12) will tend to be in tension along their entire outer edges if the base 50A and lid 70A are moved further open beyond the as-molded open condition (i.e., if the lid 70A is bent downwardly from the as-molded position illustrated in FIG. 10).

The above-described hinge structure illustrated in FIGS. 10-18 offers a number of advantages over widely used polypropylene snap-action hinges. For example, a currently employed prior art snap-action hinge molded from polypropylene must be manually opened beyond the over-center point and fulcrum point before the lid will be automatically biased by the hinge toward the full open position. The hinge structure of the present invention illustrated in FIGS. 10-18 will tend to pull the lid to the open position as soon as the latching beads (base bead 68A and lid bead 86A shown in FIG. 10) are disengaged.

Also, the present invention hinge structure shown in FIGS. 10-18 will tend to move the base 50A and lid 70A further apart to a more wide open orientation—closer to the original as-molded configuration.

Further, with the hinge structure of the present invention as shown in FIGS. 10-18, the maximum period of time in which the closure should be initially closed after molding is not as critical owing to the presence of the elastomeric element 104A.

If the elastomeric element 104A is incorporated in the closure by means of bi-injection molding, the closure body or base 50A and the lid 70A are preferably provided with a pad 132A and a pad 130A, respectively, to simplify or enhance the molding process In the same manner as described above for the first embodiment illustrated in FIGS. 1-9.

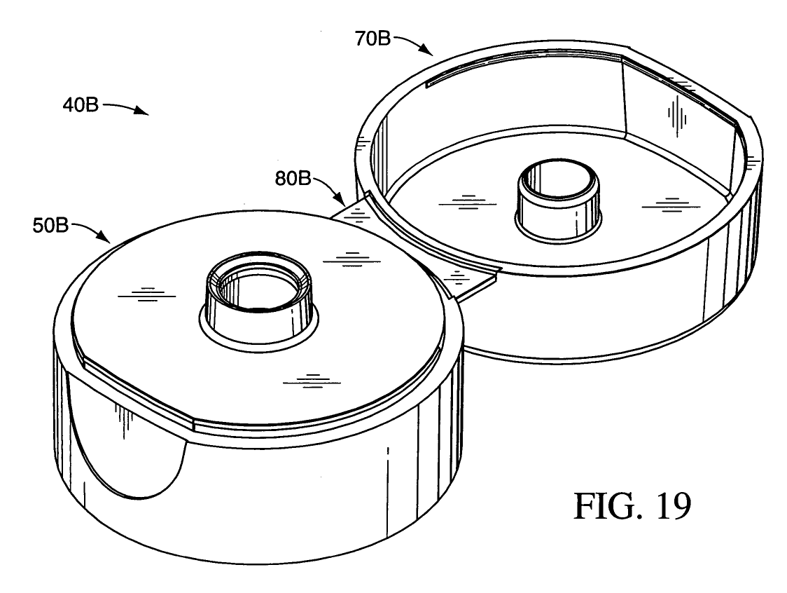

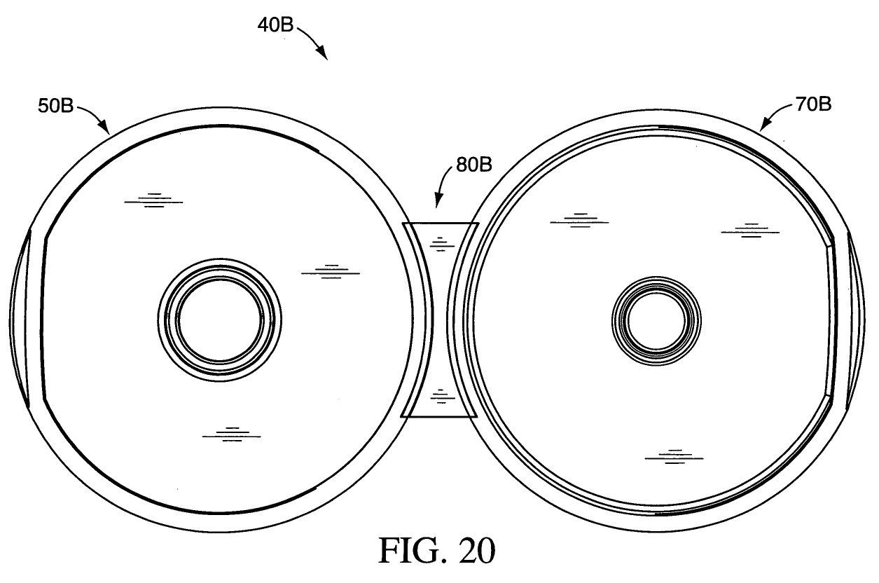

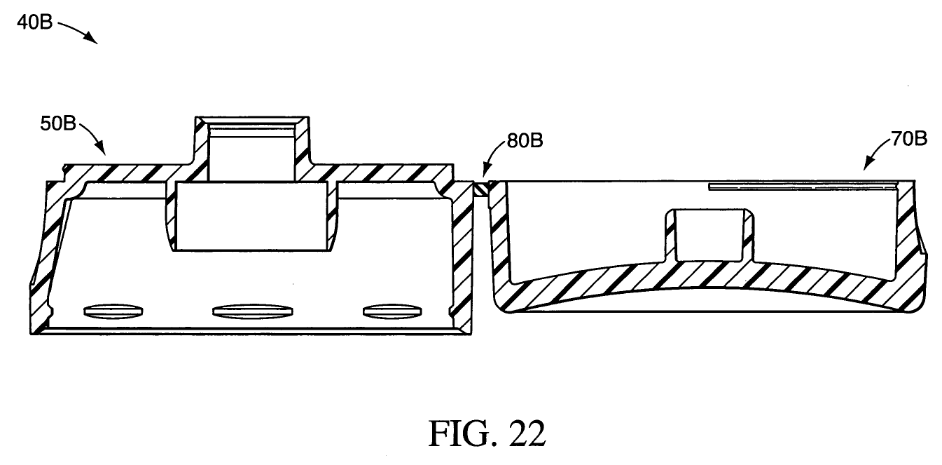

A third embodiment of the hinge structure of the present invention is illustrated in FIGS. 19-27 for a closure 40B and is designated generally therein by reference number 80B. The hinge structure 80B includes an elastomeric element 104B connecting two members of a closure structure—the closure body or base 50B and the lid 70B (FIG. 19). The closure body 50B and the closure lid 70B each has substantially the same structure as the closure body 50A and lid 70A, respectively, discussed above with reference to the second embodiment illustrated in FIGS. 10-18.

The hinge structure 80B includes an elastomeric element 104B which is similar to the elastomeric 104A discussed above with respect to the second embodiment illustrated in FIGS. 10-18. However, in the third embodiment of the hinge structure, the elastomeric element 104B includes top and bottom edges that have a somewhat different configuration compared with the top and bottom edges of the second embodiment of the elastomeric element 104A discussed above with reference to FIGS. 10-18 as will be explained in more detail hereinafter.

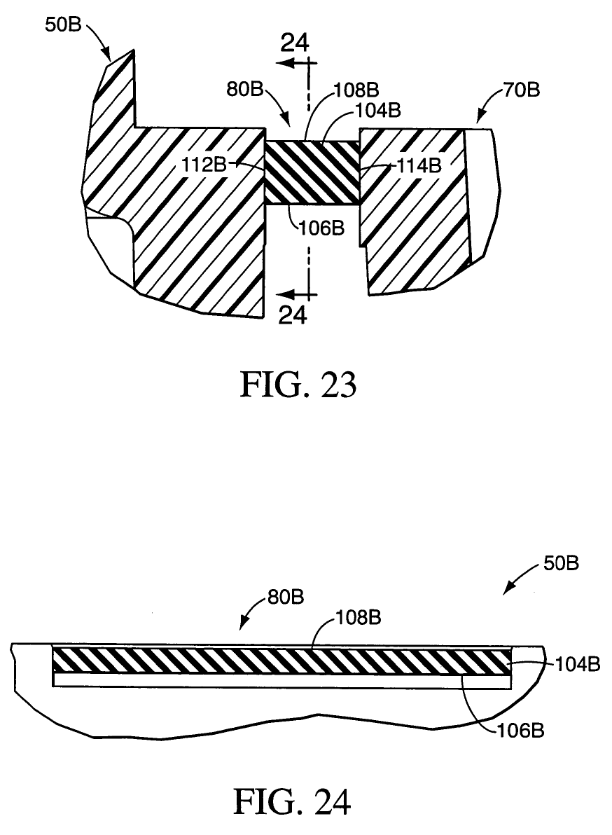

With reference to FIG. 23, the elastomeric element 104B of the third embodiment of the hinge structure has an outer surface 106B and an inner surface 108B. When the lid 70B is closed, the inner surface 108B faces toward the closure body 50B and lid 70B (FIG. 26). In the closed condition, the elastomeric element 104B is in tension along the outer surface 106B and is in compression along the inner surface 108B.

The elastomeric element 104B is molded or otherwise constructed in an initially open condition (FIG. 23) so that the outer surface 106B and the inner surface 108B are each substantially unstressed. As with the elastomeric element 104A of the second embodiment described above with reference to FIGS. 10-18, the third embodiment elastomeric element 104B has transverse ends abutting the closure elements—a transverse end 112B which abuts, and is attached to, the exterior peripheral surface of the closure base 50B, and a transverse end 114B which abuts, and is attached to, the exterior peripheral surface of the lid 70B. The ends of the elastomeric element 104B are attached by molding the element 104B between the closure base 50B and lid 70B or by attaching it with other means, such as adhesive. A bi-injection molding process may be employed for a preferred form of the structure wherein the closure body 50B and lid 70B are molded from a thermoplastic polymer, such as polypropylene, and the elastomeric element 104B is molded from a thermoplastic polymer, such as a thermoplastic rubber as discussed above with respect to the second embodiment.

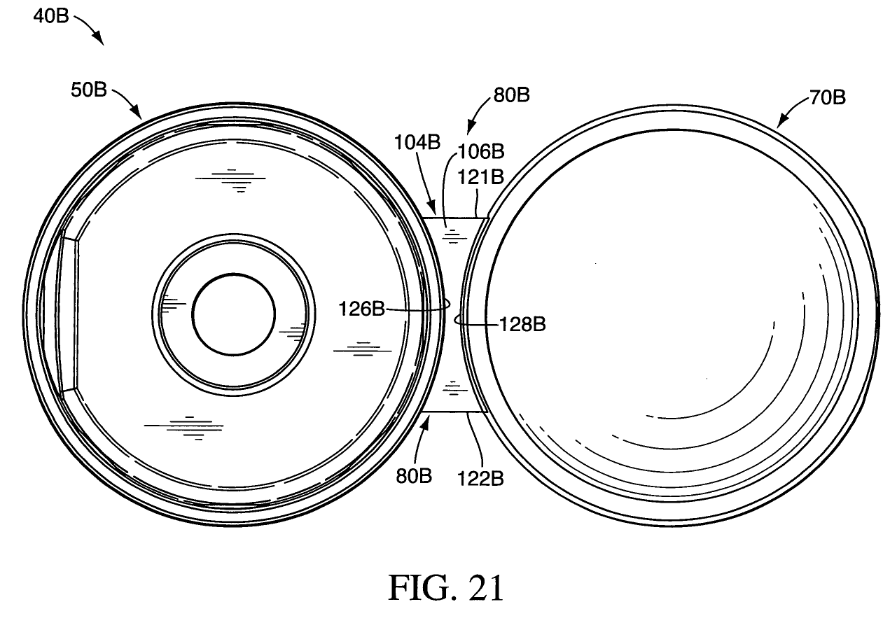

The elastomeric element 104B has two lateral margins 121B and 122B (FIG. 21). These margins are substantially parallel and are laterally exposed when the closure base 50B and lid 70B are in the closed position as well as when the closure base 50B and lid 70B are in the open position. The lateral margins 121B and 122B are wider than the central part of the hinge structure as can be seen in FIG. 21.

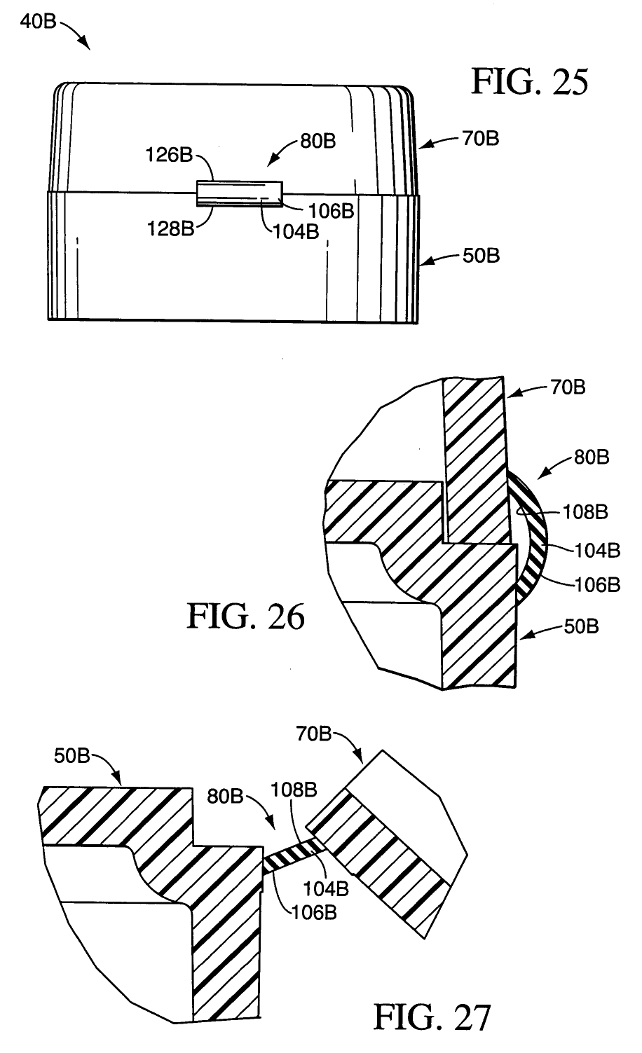

With reference to FIG. 25, it can be seen that the elastomeric element 104B has top and bottom edges 126B and 128B, respectively, which are generally parallel and horizontally disposed relative to the opening and closing plane of the closure 40B. This is in contrast with the elastomeric element 104A of the second embodiment illustrated in FIG. 16 wherein the top and bottom edges 126A and 128A, respectively, are arcuate in the generally vertical or axial directions. The top and bottom edges 126B and 128B of the third embodiment of the hinge structure are, however, arcuate in the generally horizontal planes parallel to the opening plane of the closure, and such arcuate configurations in the horizontal planes can be seen in FIG. 21 which illustrates an initial, as-molded, open configuration of the closure 40B which employs the third embodiment of the hinge structure 80B.

When the third embodiment of the hinge structure 80B is in the fully open position, the stress through the center of the elastomeric element 104B is substantially the same as the stress along the lateral edges 121B and 122B.

It is seen that the present invention thus provides an improved hinge structure which is especially suitable for use in a closure wherein it is desired that the lid operate so as to be biased toward a fully opened position.

The hinge structure protrudes minimally from the rear of the closure when the closure lid is in the closed position. This is compatible with high speed closure applying machinery employed in conventional container product filling lines. This permits the closure to be used with containers processed at high line speeds.

The hinge structure can be designed to provide a small or large biasing force and a small or large lid opening angle.

It will also be appreciated that the closure may be provided with a variety of dispensing passage structures.

The hinge structure of the present invention is particularly well suited for use in joining a closure body or base and a closure lid. However, the present invention also contemplates that the hinge structure may be used in other applications to connect components or elements other than a closure base and lid.

It will be readily observed from the foregoing detailed description of the invention and from the illustrations thereof that numerous other variations and modifications may be effected without departing from the true spirit and scope of the novel concepts or principles of this invention.

What is claimed is:

1. A hinge structure for connecting two members to accommodate movement between an open position and a closed position, said structure comprising:
an elastomeric element extending from one of said members to the other of said members; said elastomeric element having an outer surface that is outwardly exposed when said two members are in said closed position as well as when said two members are in said open position; said elastomeric element having two lateral margins; said hinge structure being free of structure laterally of said elastomeric element so that said two lateral margins are laterally exposed when said two members are in said closed position as well as when said two members are in said open position; said elastomeric element outer surface being in tension when said two members are in said closed position; and said elastomeric element exerting a force to urge said two members from said closed position toward said open position.

2. The hinge structure in accordance with claim 1 in which said
elastomeric element has two transverse end faces;
one of said two end faces is bonded to one of said two members; and
the other of said two end faces is bonded to the other of said two members.

3. The hinge structure in accordance with claim 1 in which said elastomeric member has an inner surface that is exposed to face away from said two members when said two members are in said open position and that faces inwardly toward said two members when said two members are in said closed position.

4. The hinge structure in accordance with claim 1 in which said elastomeric element is bi-injection molded with said two members.

5. The hinge structure in accordance with claim 1 in which
said hinge structure further includes a film hinge connecting said two members;
an elastomeric element has an inner surface bonded to said film hinge; and
said elastomeric element inner surface is a substantially neutral stress surface when said two members are in said closed position.

6. A hinge structure for connecting two members to accommodate movement between an open position and a closed position, said structure comprising:
a film hinge connecting said two members; and
an elastomeric element extending from one of said members to the other of said members; said elastomeric element having an outer surface that is (1) outwardly exposed when said two members are in said closed position as well as when said two members are in said open position, and (2) in tension when said two members are in said closed position; said elastomeric element having an inner surface that is bonded to said film hinge and that is a substantially neutral stress surface when said two members are in said closed position; and said elastomeric element exerting a force to urge said two members from said closed position toward said open position.

7. The hinge structure in accordance with claim 6 in which said
elastomeric element has two transverse end faces;
one of said two end faces is bonded to one of said two members; and
the other of said two end faces is bonded to the other of said two members.

8. The hinge structure in accordance with claim 6 in which said elastomeric element is bi-injection molded with said film hinge and said two members.

9. The hinge structure in accordance with claim 6 in which said hinge structure is adapted for a closure for a container opening wherein said closure includes (1) one of said two members functioning as a base for mounting to said container over said opening and defining a discharge aperture communicating with said opening, and (2) the other of said two members functioning as a lid movable between a closed position occluding said aperture and an open position spaced from said aperture.

10. A hinge structure for connecting two members to accommodate movement between an open position and a closed position, said structure comprising:
an elastomeric element extending from one of said members to the other of said members; said elastomeric element having an outer surface that is (1) outwardly exposed when said two members are in said closed position as well as when said two members are in said open position, and (2) in tension when said two members are in said closed position; said elastomeric element having an inner surface that is exposed to face away from said two members when said two members are in said open position and that faces inwardly toward said two members when said two members are in said closed position; said elastomeric element inner surface being in compression when said two members are in said closed position; and said elastomeric element exerting a force to urge said two members from said closed position toward said open position.

11. The hinge structure in accordance with claim 10 in which said
elastomeric element has two transverse end faces;
one of said two end faces is bonded to one of said two members; and
the other of said two end faces is bonded to the other of said two members.

12. The hinge structure in accordance with claim 10 in which said elastomeric element is bi-injection molded with said two members.

13. The hinge structure in accordance with claim 10 in which said hinge structure is adapted for a closure for a container opening wherein said closure includes (1) one of said two members functioning as a base for mounting to said container over said opening and defining a discharge aperture communicating with said opening, and (2) the other of said two members functioning as a lid movable between a closed position occluding said aperture and an open position spaced from said aperture.
